(19) United States
(12) Patent Application Publication
(10) Pub. No.: US 2021/0252737 A1
(43) Pub. Date: Aug. 19, 2021

(54) PROCESS FOR THE PRODUCTION OF A WOOD PART CONNECTION AND DEVICE TO CARRY OUT THE PROCESS

(71) Applicant: Armin HUMMEL, Böhen/Allgäu (DE)

(72) Inventor: Armin HUMMEL, Böhen/Allgäu (DE)

(21) Appl. No.: 16/973,693

(22) PCT Filed: Jun. 10, 2019
(86) PCT No.: PCT/EP2019/000179

§ 371 Date: Dec. 9, 2020

(30) Foreign Application Priority Data
Jun. 9, 2018 (DE) 10 2018 004 541.3

(51) Int. Cl. B27M 3/00; E04B 5/12

(52) U.S. Cl. CPC B27M 3/0053; B27F 1/02; E04B 5/12

(57) ABSTRACT

The invention relates to a simple and safe method for manufacturing a wood part joint, in particular a cross-laminated timber for a house wall, from a plurality of individual layers which are laid as longitudinal layers (L) and transverse layers (Q) at an angle to one another and subsequently joined, preferably glued and pressed, at their mutually facing main surfaces. According to the invention, at least the boards of the longitudinal layer (L) are pre-fixed in their transverse direction using an elongate string element (2) at least in the end region, in particular using beading pressed into a groove. The invention also relates to a corresponding device for carrying out the method, wherein a feed for the elongate string element (2) is provided which can independently also be used for a wood part joint in which abutting, shorter pieces of wood are pre-fixed in the longitudinal direction to a board.

The invention relates to a method for producing a wood part connection, in particular a cross-laminated timber element for a house wall, and a device for this purpose. In particular, this is (these are) used for the assembly connection of loose adjacent wooden slats.

Cross-laminated timber elements are formed from board layers laid angled, in particular at right angles to one another (individual layers, often also referred to as longitudinal and transverse layers) and joined under pressure. These elements, in particular in the form of a wall panel or also as a cover plate, have a high static strength, especially if more than three individual layers are provided. Hence often five or seven (or more) such layers per wall panel are glued together, also for reasons of thermal insulation for an outer wall of a wooden building. Due to the high strength, such cross-laminated timbers are increasingly used in larger office buildings or industrial buildings, for example having wall or ceiling panels with up to 20 m length and approx. 4 m height (resp. width with horizontal installation position) in order to be able to assemble them as quickly as possible. Depending on the purpose and means of transport, the dimensions may vary, e.g. also larger widths can be provided for ceilings in stairwells, as well as L- or T-shaped basic dimensions.

Such wooden board elements are formed from several individual layers, each individual layer consisting of several boards placed next to one another (also referred to as lamellas). These boards are usually finger-jointed and planed due to their great length of 15 m and more. When laying them next to each other, the curvature and/or torsion of the individual lamellas can create considerable gaps between adjacent narrow edges of the boards, which are eliminated with the most commonly used joint gluing under transverse pressure. However, the gluing of the joints is quite material and time-consuming, especially since different press systems are required. Hence joint gluing is increasingly dispensed with, but there is the problem that due to the aforementioned warpage, the individual layers are designed with a “larger” surface than the end surface. In addition, due to the internal tension of the lamellas, a curvature occurs in the vertical direction relative to the table surface. In order to prevent transverse lamellas from falling down on the end faces of the longitudinal boards, it has also been proposed to leave several longitudinal boards protruding outwards. However, this means additional material expenditure (waste) or expenditure of time in order to push back the protruding boards in the stack of layers. Furthermore, this movement can partially scrape off the glue that has already been applied, so that the glue quality can be impaired.

Another problem lies in the handling of the loose lamellas by manipulators (usually a large-area vacuum gripper) with which the boards are transported to the gluing station in order to ultimately remove the so-called forming “press cakes” from alternately stacked longitudinal and transverse layers. However, vacuum technology only works reliably if there are no major deviations due to twisted or raised individual lamellae, so that individual lamellae could fall off. In this case there is a risk that the so-called open glue window is exceeded by a few minutes and thus the entire pressing could become unusable. In addition, there are considerable dangers for the staff if an attempt is made to manually reload fallen slats.

The aforementioned spline (often also referred to as “finger-jointing”) for connecting pieces of wood (short lamellas) made of solid wood lying next to one another in the longitudinal direction is, however, quite complex, since with relatively short pieces of wood (as is useful for wood recycling) this finger-jointing is required at every transverse joint. These boards are finger-jointed 10 or more times due to the great length of usually more than 10 m.

The present invention is therefore based on the object of creating a method for producing a partial wood connection, in particular a cross-laminated timber, and a device for this, in order to make its production simpler and more flexible, in particular also with a reliable process.

This object is achieved with a method according to claim 1 and a corresponding device and a wooden part connection thus produced. Advantageous configurations are the subject of the sub-claims.

The proposed method allows the board timber element to be produced to be laid in a process-reliable manner from the required individual layers, then to be glued and transferred to a press. Due to the pre-fixing, the initially loose boards can be safely transported, in particular with a vacuum suction lifter or conveyor belts, whereby the cohesion created by elongated string elements prevents too great a deviation from the “ideal” board shape, as the gaps and/or bends between the individual boards are minimized. The individual layer laid and pre-fixed in this way is relatively close to the final dimension of the CLT element, i.e. largely without gaps, so that excessive cross or longitudinal grouting paths are avoided, which significantly reduces the construction effort and the process time of the entire system.

The proposed method for producing a wood part connection is characterized in that at least the boards or lamellae of the longitudinal position in their transverse direction at an angle (in particular 90°) to the respective board axis are pre-fixed at least in the end area with an elongated string element, in particular are braced with a beading. The thread-like string element is preferably formed from a plastic, textile or metal wire with a preferably round cross-section, but can also be ribbon-shaped or made of high-tensile natural fibers (e.g. sisal, jute, hemp). The beading that is preferably used is inserted into a groove under tensile stress and clamped there so that lamellas (or generally abutting pieces of wood) are pulled against each other and cannot gape apart again. The gap dimensions are thus minimized, so that the individual layer laid is close to the desired final dimension due to the pre-fixing.

Both the longitudinal layers and the transverse layers are preferably pre-fixed in this way, wherein the risk of gaping apart and a formation of gaps is usually larger in the longitudinal layers due to the great length (of e.g. >15 m) of the slats, while with transverse layers the relatively short slats at their narrow edges fit together better. However, since the number of lamellas is considerably larger in the case of transverse layers, a pre-fixing with at least one string element is also useful there. In order to increase the pre-fixing effect of the beading, the groove is preferably sawed or milled at an angle to the main surface of the boards, so that the wire-shaped string element is clamped better and the transferable prestressing or tensile force between the lamellas is increased in order to keep the gap size small.

In the proposed method, the string element, in particular in the form of a beading or nylon fishing line, is pulled off a supply roll and pressed into the transverse saw groove in the tensioned state so that the lamellas lying close together on the laying table do not gape apart again due to internal tension (axial pretension). This axial preload cannot be provided by wooden strips, especially since long, narrow wooden strips often splinter and can hardly be produced in the required lengths. In contrast to wooden strips, the string element is pressed in quite easily and practically simultaneously or shortly after a sawing or milling station to make the saw groove due to the intrinsic elasticity of the beading in the transverse direction. Although the pre-fixing at the end areas may be sufficient for continuous CLT elements, the string elements or beading for cutouts for building openings (windows or doors) is provided on the edge thereof in order to improve the overall handling of the CLT elements with conveyor systems. The beading does not have to run parallel to the window or door edge, but can also run at an angle to it in order to increase the fixation in several dimensions.

This principle is also advantageous for joining pieces of wood (short lamellas) in longitudinal direction for individual boards (e.g. also for glue binders as a special form of cross-laminated timber). Due to the integration between cover layers or by appropriate turning, the grooves and beading in the finished wooden parts, usually boards of for instance 8 or more meters in length, consisting of for instance 20 pieces of wood of different lengths are no longer or barely visible. The introduction of the pre-fixing and conveying of the pre-fixed individual layers can thus take place very quickly.

The proposed device for carrying out the method described is characterized in that a laying table is provided for pre-fixing the boards, in particular with a beading, on which a feed for the string element is arranged. This device is preferably arranged directly above the laying table like a portal and has a milling cutter or saw adjacent to the feed, which creates the groove approximately in the transverse direction of the boards placed next to one another in the transverse passage (or an angle slightly different therefrom), wherein preferably a vacuum device is also arranged on the saw or milling machine. In addition, at least one pressure roller for the beading should be arranged adjacent to the milling cutter or saw, so that this string element inserted into the groove is pretensioned and pre-fixed to the lamella packet with small gaps thus holding them together. Due to the obliquely angled alignment of the groove, this cohesion can act in several dimensions, i.e. it can also hold down lamellae standing upright.

The finished pressed elements are sawn to their final dimensions after pressing, as are the building openings. It is advantageous compared to pre-glued panels that the cut-out areas for windows or doors are not glued (i.e. excluded from the so-called glue portal) and therefore do not constitute waste. This considerably improves the economy of the process. The fitting together of the individual longitudinal layers or cross layers can also take place outside the press above the laying table or during or after transfer into the press. Such prepared bundles of layers can be pushed laterally or lengthways into the press with a conveyor belt, if necessary also turned before gluing, so that the grooves and beading are not visible on the finished panel. The alternating gluing of the individual longitudinal layers and then the transverse layers (or the transverse joints in the case of individual boards) can also be carried out directly in the press, so that the laying on the transverse or Longitudinal laying table with the introduction of the pre-fixing and conveying of the pre-fixed longitudinal and transverse layers can take place almost continuously and thus very quickly.

An exemplary embodiment of the invention is described below with reference to the drawing. In these:

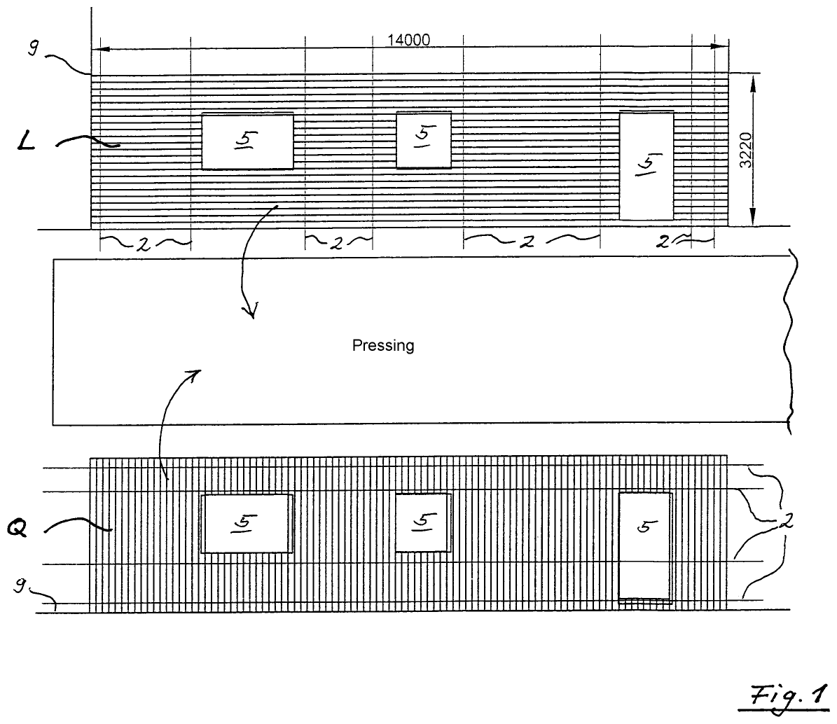

FIG. 1 shows a schematic plan view of a device for laying a longitudinal layer and a transverse layer, each to the side of a press;

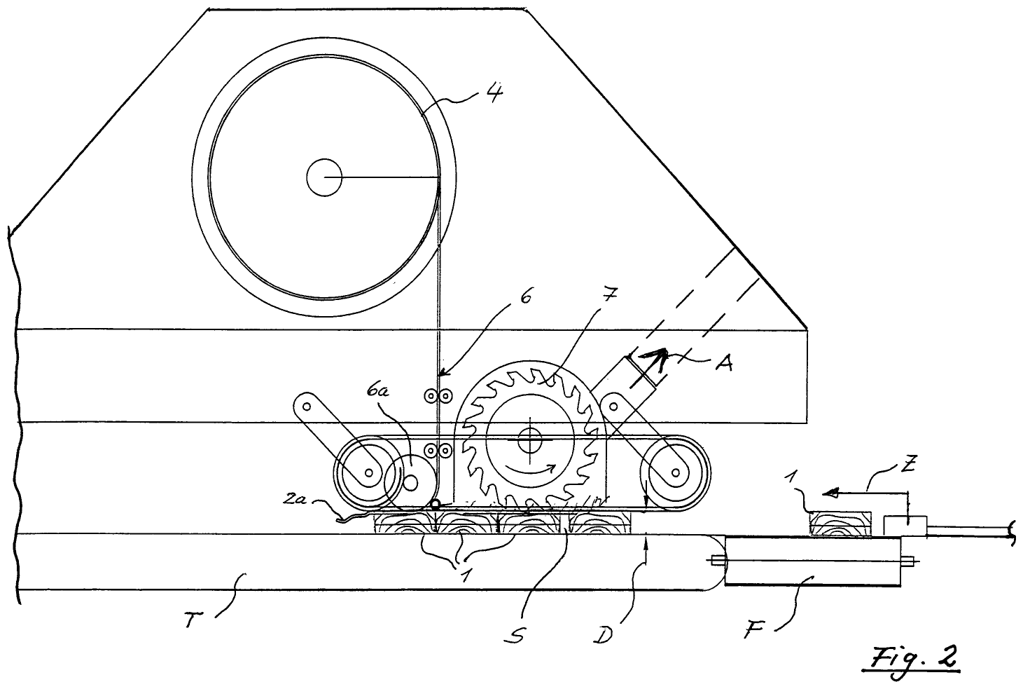

FIG. 2 shows a side view with a circular saw for making a saw groove and feeding a string element to the lamellae or boards;

FIG. 3 shows a board layer in a schematic perspective view;

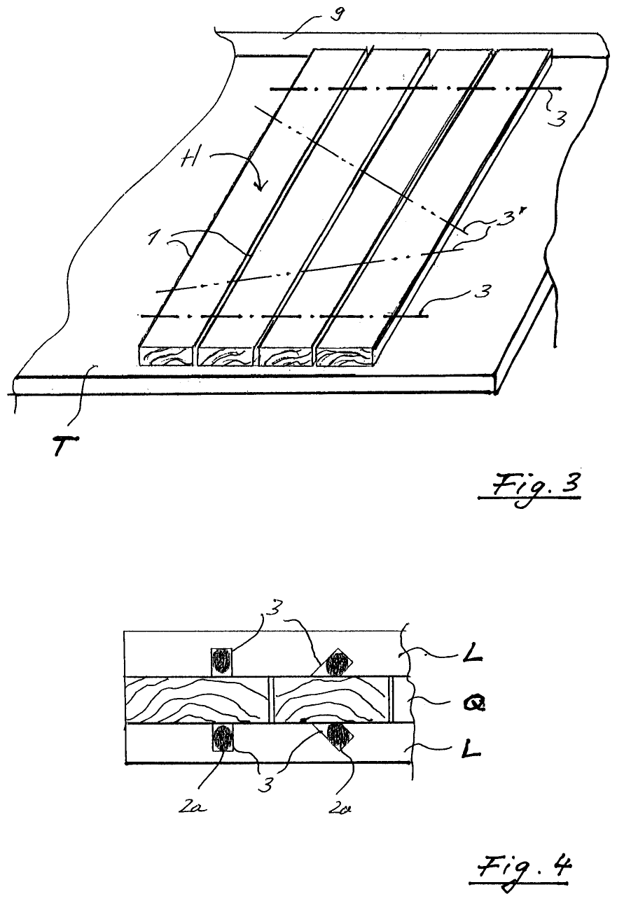

FIG. 4 shows a schematic cross section through three CLT layers;

FIG. 5 shows a schematic perspective view of a wood part connection in board shape;

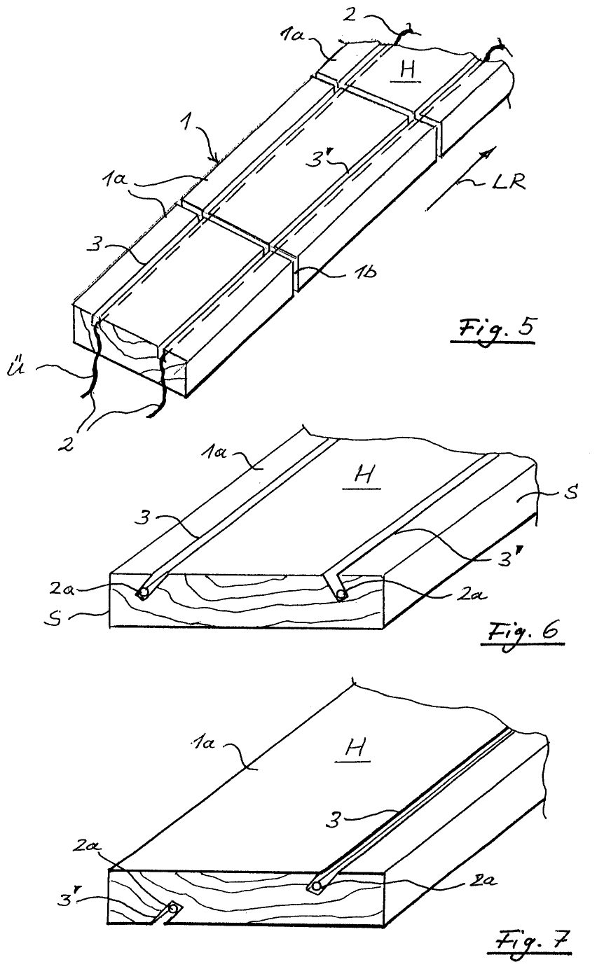

FIG. 6 shows an end view of a piece of wood with two obliquely running grooves; and

FIG. 7 shows an end view of a board section with offset grooves.

FIG. 1 shows a schematic plan view of a press in which several longitudinal layers L and transverse layers Q are manufactured to form a cross-laminated timber element (CLT).

The longitudinal layer L shown above has a length of 14 m and (in the wall version) a height of over 3 m, for instance. The same applies to the transverse layer Q shown below, which consists of a large number of boards 1 (compare FIG. 3) is compiled (so-called. “Lay”). According the laying direction different by 90° for instance, the laying tables arranged on the right and left of the press have a stop rail 9 offset at right angles (see also FIG. 3). After the respective longitudinal layer L and transverse layer Q have been put together, they are transferred to the press in layers, as indicated by the arched arrows, and after the glue has been applied (glue application only on the main surface H; compare FIG. 3) pressed into a CLT element. Other joining methods are also possible. This ensures a secure connection of the individual slats with boards of adjacent individual layers, with cutouts 5 for windows or doors also being arranged congruently.

What is presently essential is the introduction of string elements 2 in the transverse direction to the board course, preferably in the form of beadings. The term “transverse direction” is not limited to 90° here, but can be e.g. also be 80° to the board direction (compare FIG. 3). In the longitudinal position L, eight such beadings 2a (compare also FIG. 4) are provided here, namely in each case at the end regions and adjacent to the three openings 5. In the transverse position Q, “only” four string elements 2 are required, namely again at the end areas (here above and below) and along the windows. The beading 2a continues through the door shown here on the right in order to ensure the connection to the right end area, namely a certain pre-tension between the individual slats. Thus, the individual boards are pre-fixed at their narrow edges and thus the individual layer is held together as a package or component so that it can be transported into the press (here in the middle) for pressing (e.g. each with a side roller conveyor). The beading 2a extending through the door is then cut off on the construction site.

FIG. 2 shows the laying process with four boards 1 here on a laying table T, onto which a further lamella 1 (here on the right on a conveyor belt F) is shifted intermittently by means of a feed slide Z. The incoming lamella 1 is pressurized here by conveyor belts (arrow D) and pushed against the boards 1 that have already been laid, so that the respective gap S at the narrow edges is minimized. A feed 6 (here with a plurality of rollers) and a supply roll 4 for the wire-shaped string element 2, in particular a beading 2a, is provided above the thus prepared package of laid boards 1. The (a few centimeters) protruding beginning of the beading 2a (see. also FIG. 1, with the protruding ends of the string element 2 or FIG. 5 with the protrusion U) can be seen here on the left end board after passing through a pressure roller 6a. For a better hold on the end area of the transversely elastic, largely tensile-strength beading 2a can also be folded slightly, in particular in the form of a metal wire, preferably made of relatively soft aluminum or copper, in order to prevent affecting subsequent processing. Projections of the string element 2 can thus be easily removed with a side cutter after pressing or on the construction site.

The beading 2a is preferably pressed into a groove 3 (compare FIGS. 3 and 4), which is simultaneously cut (or milled) as the boards 1 pass under the feeder 6. This takes place with boards 1 that are tightly joined to one another, that is to say with a small gap at the side edges S, so that the string element 2 is tensioned or pre-fixed and holds the slats together on and after the pressure roller 6a. The saw 7 thus cuts a groove 3 which runs (largely) transversely to the main direction of the boards and in which the beading 2a is clamped with pretension in order to hold the pack of boards of one layer together securely. The saw 7 is here equipped with a vacuum system A in order to keep the created groove 3 clean.

In FIG. 3, the course of the groove 3 in the transverse direction at the end regions of the boards 1 is drawn in dash-dot lines, also schematically the laying table T with a stop rail 9. Only four lamellas are shown here, with approximately thirty (long) boards being required for a longitudinal layer L, depending on the dimensions, and around a hundred (shorter) boards 1 for a transverse position. The groove 3 can also be incorporated at an angle other than 90°, as indicated by double-dot-dash lines 3, in order to improve the cohesion of the board package of an individual layer.

FIG. 4 shows a cross section through a CLT element with only three layers here, although seven (or more) individual layers are usually used for outer walls. The beading 2a pressed into the grooves 3 can be seen here, which avoids a gaping in the gap area between the boards 1 via clamping forces and/or friction in the groove 3 and/or minimizes it under axial prestress. For further anchoring in the groove 3, it can also be oriented at an oblique angle, as is indicated in the right-hand area of FIG. 4.

In the longitudinal layer L at the top here, the grooves 3 point downwards in order to offer the CLT element a smooth outer surface. For this purpose, for instance the package shown in FIG. 3 can be turned “upside down”, or the saw 7 (or an end mill) can be arranged below the laying table T (with appropriate slots) and the line element 2 (beading 2a) can be fed from below. Since the chips can then fall down, a vacuuming can (largely) be dispensed with.

FIG. 5 shows a schematic view of a wood part connection for forming a long board from several pieces of wood 1a (short slats or board sections). The pieces of wood 1a can, for instance have a minimum length of 30 cm, depending on the cutting and sorting, board sections of 1 meter or more can be used. Thus, in FIG. 1, the left piece of wood 1a is for instance 40 cm long, the following at a transverse joint 1 for instance 50 cm and the subsequent board section for instance is 90 cm. In order to configure a board 1 with that of 14 m in length, for instance (for a glue binder or a longitudinal layer L), for instance 20 pieces of wood (of different lengths) are joined together at 19 transverse joints. The transverse joint 1b is designed as a butt joint (possibly with a glue joint) so that complex finger joints can be dispensed with. According to the innovation, at least one groove 3 (here two grooves 3 and 3′) is incorporated into the main surface H, into which an elongated string element 2 is inserted, in particular with prestress in the form of a beading 2a. Hereby the board sections are pressed together at their transverse joints 1b, so that a safe pre-fixing of the individual board sections is achieved.

What is essential here is the introduction of string elements 2 in the longitudinal direction LR (along the board), preferably in the form of beadings 2a (so-called beading cord) with axial pretension. Presently, two such beadings 2a (compare also FIGS. 2 and 3) are provided. By pressing the beading 2a into the groove 3 (or Groove 3′) there is a certain pre-tension between the individual pieces of wood 1a. Thus, the individual board sections are pre-fixed at their transverse joints 1b and thus the board 1 held together as a single layer or component so as to, for instance to be transported to a press (for instance each with a side roller conveyor). Since the beading 2a running through the board 1 has an end protrusion U, the board assembled in the longitudinal direction L can also be gripped well manually (or a gripping device) and for instance be transported by two workers or a conveyor system. The same applies to robots, the joined board preferably being turned by 180° so that the string elements 2 are at the bottom and thus avoid sagging.

FIG. 6 shows a face view of a board section, the two grooves 3, 3′ here inclined at an angle of approximately 30° to the main surface H to improve the anchoring of the string element 2 in the respective groove. For this purpose, the beading 2a can also have a structured surface, in particular in the form of a plastic thread (e.g. made of nylon in the manner of a fishing line) or metal wire, preferably made of relatively soft aluminum or copper, so as not to impair subsequent processing. The protrusions U of the string element 2 can be easily removed after pressing or on the construction site with a side cutter or scissors.

The beading 2a is preferably pressed into the groove (s) 3, 3 with a pressure roller, which is cut (or milled) simultaneously as the board sections pass through. The string element 2 can have a slightly larger diameter (e.g. 6 mm) than the groove width (e.g. B. manufactured with 5 mm). This takes place with pieces of wood 1a closely joined together, i.e. with a slight transverse joint 1b, so that the string element 2, which is tensile in the longitudinal direction L but still slightly elastic, is axially braced or pre-fixed and holds the board sections together. The string element 2 is therefore (in contrast to wooden strips or wooden dowels) clamped with pretension in the groove 3 serving as a beading strip, in order to hold the board sections together practically without impact.

In FIG. 7, the grooves 3, 3′on opposite main surfaces H of the board sections are shown. Here too, the grooves 3, 3′are incorporated at an angle other than 90° relative to the main surface H in order to improve the clamping effect of the pressed-in beading 2a and thus the cohesion of the board sections in the longitudinal direction L. The tensile beading 2a pressed into the grooves 3, 3 avoids or minimizes a gaping between a respective cross joint 1b between the board sections due to its axial clamping forces or friction in the respective groove 3, 3′. The lower string element 2 (beading 2a, as is usually the case as rolled goods, so-called. Beading cord available) to the left side edge S can also be fed from below, whereby the saw (or a milling cutter) to form the groove 3′also dips into the board sections from below.

1. Method A method for producing a wood part connection, in particular a cross-laminated timber for a house wall, made of several individual layers, which are preferably laid as longitudinal layers (L) and transverse layers (Q) at an angle to one another and finally joined, preferably glued and pressed, on their main surfaces (H) facing one another, characterized in that
at least the boards of the longitudinal layer (L) are pre-fixed in their transverse direction with an elongated string element at least in the end area, in particular with a beading each.

2. The method according to claim 1, wherein the beading consists of a plastic, textile or metal wire or tensile natural fibers.

3. The method according to claim 1, wherein the beading is inserted into a sawed-in or milled-in groove, in particular employing an axial preload.

4. The method according to claim 3, wherein the groove is cut at an angle to the main surface (H) of the boards.

5. The method according to claim 1, wherein the String element is pulled off a roller and pressed into the groove, in particular with an axial preload.

6. Method according to claim 1, wherein the beading is provided on the edge of cutouts for building openings.

7. A device for carrying out the method claim 1, wherein a laying table (T) is provided for pre-fixing the boards, in particular with a beading, above or below which a feed for the elongated string element is arranged.

8. The device according to claim 7, wherein a milling cutter or saw is arranged adjacent to the feed, which preferably generates the groove in the transverse passage of the boards.

9. The device according to claim 8, wherein the milling cutter or saw can be moved over the respective individual layer (L or Q) by means of a portal.

10. The device according to claim 8, wherein at least one pressure roller for the beading is arranged adjacent to the milling cutter or saw in order to press it into the groove, in particular with an axial preload.

11. The device according claim 7, wherein the groove is oriented at an oblique angle to the longitudinal axis of the boards.

12. A wood part connection for several pieces of wood, in particular for boards, planks or lamellas for use according to claim 1, with at least one transverse joint on which the pieces of wood are joined, in particular glued, in the longitudinal direction of the boards, planks or lamellas, wherein the pieces of wood are pre-fixed in their longitudinal direction (LR) to form a board with a string element, in particular that they are braced with a beading.

13. The wood part connection according to claim 12, wherein the beading consists of a plastic strand, textile or metal wire or tensile natural fibers.

14. The wood part connection according to claim 12, wherein the transverse joint is designed as a butt joint.

15. The wood part connection of claim 12, wherein two grooves are provided which are arranged on opposite main surfaces (H) of the pieces of wood forming a board, wherein preferably the two Grooves are arranged offset towards opposite narrow edges (S) of the pieces of wood.
